(19) United States
(12) Patent Application Publication
(10) Pub. No.: US 2022/0372203 A1
(43) Pub. Date: Nov. 24, 2022

(54) A POLYURETHANE GEL FOR MEDICAL PADDING APPLICATION

(71) Applicant: BASF SE, Ludwigshafen am Rhein (DE)

(72) Inventors: Michael Jae LUBITZ, Bridgeville, PA (US); Gregory W CARROLL, Wyandotte, MI (US); Lyle CAILLOUETTE, Wyandotte, MI (US); Stephen M SMITH, Wyandotte, MI (US)

(21) Appl. No.: 17/753,757

(22) PCT Filed: Oct. 6, 2020
(86) PCT No.: PCT/EP2020/075858

§ 371 Date: Mar. 14, 2022

Related U.S. Application Data
(60) Provisional application No. 62/901,315, filed on Sep. 17, 2019.

(30) Foreign Application Priority Data
Dec. 12, 2019 (EP) 19215547.1

(51) Int. Cl. C08G 18/10; C08G 18/76; C08G 18/48; C08G 18/24

(52) U.S. Cl. CPC C08G 18/10; C08G 18/7671; C08G 18/485; C08G 18/246; C08G 2220/00

(57) ABSTRACT

Described herein are a polyurethane gel, a process for preparing the same, and applications for the use thereof in medical padding.

### FIELD OF INVENTION

The present invention relates to a polyurethane gel, a process for preparing the same and applications for the use thereof in medical padding.

### BACKGROUND OF THE INVENTION

Gels, such as polyurethane gels, are utilised to enhance tactile properties such as firmness, support, resiliency and compression resistance. U.S. Pat. No. 4,535,096 A discloses polyester urethane foams having strength, acceptable softness, and flame retardance. U.S. Pat. No. 9,062,174 B2 discloses a flexible foam encapsulating a polyurethane gel (C), the foam being obtained by reacting an isocyanate component (A) and an isocyanate reactive component (B), where (A) and (B) react in presence of (C). The polyurethane gel and/or the gel substrates may be dispersed in the foam. The gel (C) polyurethane gel comprises the reaction product of (1) a polyol component and (2) a second isocyanate component at an isocyanate index of from about 10 to about 70.

Medical padding may be used on a patient support equipment, a bariatric equipment, an insole, a patient mattress, a medical equipment, and the like. The medical padding provides cushion, deflects pressure from and/or protects the patient or a body part of the patient. The medical padding has to bear the load of the patient's body weight and recover from the load after the patient alight thereby showing resilience in usage. Medical paddings are also required to offer shock resistance and vibration protection. At the same time, since the medical padding is used for a long-time duration, it is required to provide comfort to the user over the course of its use.

Medical padding is often subjected to a load due to prolonged stay of the patient on the person support equipment or other device having the medical padding. The existing state of the art of polyurethane gels for application in medical padding are associated with low resilience, i.e. low rate of recovery to an original shape. The polyurethane gels of the state of the art with very hard form do not provide comfort for a prolonged stay of the patient. Moreover, such polyurethane gels are susceptible to react with skin of the user.

Thus, it was an object of the present invention to provide a polyurethane gel for medical padding which is produced in a less complex manufacturing process, provides structural resilience and at same time provides comfort as required for a long period of medical usage.

### SUMMARY OF THE INVENTION

Surprisingly, it has been found that the above object is met by providing a polyurethane gel having a Shore “OOO” hardness of 30 to a Shore “OO” hardness of 80 determined according to ASTM D2240.

Accordingly, in one aspect, the present invention is directed to a process for preparing a polyurethane gel having a Shore “OOO” hardness of 30 to a Shore “OO” hardness of 80 determined according to ASTM D2240, comprising the steps of:
(A) reacting a first mixture (M1) comprising
   (PI) at least one isocyanate and
   (P1) at least one polyol having an average functionality in between 2.0 to 4.0 and a hydroxyl number in between 10 mg KOH/g to 500 mg KOH/g,
to prepare an isocyanate prepolymer having an isocyanate content in between 4.0 wt.-% to 22.0 wt.-%, and
(B) reacting a second mixture (M2) comprising at least one isocyanate reactive compound, at least one catalyst (CA) and the isocyanate prepolymer of step (A) at an isocyanate index in between 10 to 70, to obtain the polyurethane gel, and
wherein weight ratio of the first mixture (M1) to the second mixture (M2) is between 1.0:3.0 to 1.0:5.0.

In another aspect, the present invention is directed to the above defined polyurethane gel having a Shore “OOO” hardness of 30 to a Shore “OO” hardness of 80 determined according to ASTM D2240.

In another aspect, the present invention is directed to a process for producing a polyurethane gel pad comprising at least the step of
(S) enclosing at least one polyurethane gel, as described herein, within an encapsulating material.

In another aspect, the present invention is directed to the use of the above polyurethane gel pad in an article.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may do so. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10, between 1 to 10 imply that both 1 and 10 are included in the range. For the avoidance of doubt, the applicant shall be entitled to any equivalents according to applicable law.

An aspect of the present invention is directed to a process for preparing a polyurethane gel having a Shore “OOO” hardness of 30 to a Shore “OO” hardness of 80 determined according to ASTM D2240, comprising the steps of:
(A) reacting a first mixture (M1) comprising
   (PI) at least one isocyanate and
   (P1) at least one polyol having an average functionality between 2.0 to 4.0 and a hydroxyl number between 10 mg KOH/g to 500 mg KOH/g,
to prepare an isocyanate prepolymer having an isocyanate content between 4.0 wt.-% to 22.0 wt.-%, and
(B) reacting a second mixture (M2) comprising at least one isocyanate reactive compound, at least one catalyst (CA) and the isocyanate prepolymer of step (A) at an isocyanate index between 10 to 70, to obtain the polyurethane gel, and
wherein weight ratio of the first mixture (M1) to the second mixture (M2) is between 1.0:3.0 to 1.0:5.0.

The hardness is measured by a durometer based on an ASTM D2240 testing standard. Shore “OOO” scale and a Shore “OO” scale are used to determine the hardness in a value between 0 to 100 where higher value indicates a harder material. Shore “OO” scale measures a higher range of hardness compared to the Shore “OOO” scale.

In one embodiment, the polyurethane gel has a hardness in between Shore “OOO” 30 to Shore “OO” 80, Shore “OOO” 30 to Shore “OO” 70, Shore “OOO” 30 to Shore “OO” 60, Shore “OOO” 32 to 70, Shore “OOO” 32 to 68, Shore “OOO” 35 to 68, or Shore “OOO” 35 to 65 determined according to ASTM D2240.

### Step A

For the purpose of the present invention, the Step A of the process for preparing the polyurethane gel includes reacting the first mixture (M1) comprising at least one isocyanate (PI) and at least one polyol (P1) to prepare the isocyanate prepolymer. The first mixture (M1) has an isocyanate index between 10 to 100, or between 10 to 90, or between 10 to 80, or between 10 to 70. The isocyanate index of 100 corresponds to one isocyanate group per one isocyanate reactive group.

In an embodiment, the isocyanate content of the isocyanate prepolymer is in between 4.0 wt.-% to 22.0 wt.-%, 4.0 wt.-% to 20.0 wt.-%, or 4.0 wt.-% to 18.0 wt.-%. In other embodiment, the isocyanate content of the isocyanate prepolymer is in between 4.0 wt.-% to 16.0 wt.-%, or 4.0 wt.-% to 14.0 wt.-%, or 4.0 wt.-% to 12.0 wt.-%, or 4.0 wt.-% to 10.0 wt.-%, or 4.0 wt.-% to 8.0 wt.-%.

### Isocyanate (PI)

For the purpose of the present invention, the (PI) at least one isocyanate preferably has an average functionality of at least 2.0; or in between 2.0 to 4.0. The (PI) at least one isocyanate preferably comprises of aliphatic isocyanates or aromatic isocyanates or a combination thereof. The term “aromatic isocyanate” refers to molecules having two or more isocyanate groups attached directly and/or indirectly to the aromatic ring. Further, it is to be understood that the (PI) at least one isocyanate includes both monomeric and polymeric forms of the aliphatic and aromatic isocyanate. The term “polymeric” refers to the polymeric grade of the aliphatic and/or aromatic isocyanate comprising, independently of each other, different oligomers and homologues.

In yet other embodiment, the aromatic isocyanate is selected from toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate, tolidine diisocyanate,1,3,5-triisopropyl benzene-2,4,6-triisocyanate or combinations thereof.

In yet other embodiment, the aromatic isocyanate comprises of methylene diphenyl diisocyanate and/or polymeric methylene diphenyl diisocyanate.

Methylene diphenyl diisocyanate is available in three different isomeric forms, namely 2,2′-methylene diphenyl diisocyanate (2,2′-MDI), 2,4′-methylene diphenyl diisocyanate (2,4′-MDI) and 4,4′-methylene diphenyl diisocyanate (4,4′-MDI). Methylene diphenyl diisocyanate can be classified into monomeric methylene diphenyl diisocyanate and polymeric methylene di-phenyl diisocyanate referred to as technical methylene diphenyl diisocyanate. Polymeric methylene di-phenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of higher than 2.0. The isomeric ratio as well as the amount of oligomeric species can vary in wide ranges in these products. For instance, polymeric methylene diphenyl diisocyanate may typically contain 30.0 wt.-% to 80.0 wt.-% of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene di-phenyl diisocyanate.

In yet other embodiment, the aromatic isocyanate is a polymeric methylene diphenyl diisocyanate, as described hereinabove.

### Polyol (P1)

In one embodiment, the at least one polyol (P1) comprises polyether polyols, polyester polyols, polyether-ester polyols or combinations thereof. The polyols further comprise of aliphatic polyols, cycloaliphatic polyols, aromatic polyols, heterocyclic polyols, graft polyols, and combinations thereof.

In one embodiment, the at least one polyol (P1) has an average functionality between 2.5 to 4.0.

The at least one polyol (P1) is further defined as having a hydroxyl number or the hydroxyl number between 10 to 500 mg KOH/g or between 10 to 450 mg KOH/g, or between 10 to 400 mg KOH/g, or between 10 to 350 mg KOH/g, or between 10 to 300 mg KOH/g, or between 10 to 250 mg KOH/g, or between 10 to 200 mg KOH/g, or between 10 to 150 mg KOH/g, or between 10 to 100 mg KOH/g, or between 10 to 70 mg KOH/g, or between 10 to 50 mg KOH/g.

In yet other embodiment, the (P1) at least one polyol is a polyether polyol. Suitable polyether polyols are obtained by known processes, for example via anionic polymerization of alkylene oxides with the addition of at least one starter molecule comprising from 2 to 8, or 2 to 6, reactive hydrogen atoms, in the presence of catalysts. If mixtures of starter molecules with different functionality are used, fractional functionalities can be obtained. The nominal functionality ignores effects on the functionality due to side reactions. The catalysts can be alkali metal hydroxides, for example sodium hydroxide or potassium hydroxide, or alkali metal alcoholates, for example sodium methanolate, sodium ethanolate or potassium ethanolate or potassium isopropanolate, or in the case of a cationic polymerization, the catalysts can be Lewis acids, for example antimony pentachloride, boron trifluoride etherate or bleaching earth. It is also possible to use aminic alkoxylation catalysts, for example dimethylethanolamine (DMEOA), imidazole and imidazole derivatives. The catalysts can moreover also be double-metal cyanide compounds, which are known as DMC catalysts.

The alkylene oxides are one or more compounds having from 2 to 4 carbon atoms in the alkylene moiety, for example tetrahydrofuran, propylene 1,2-oxide, ethylene oxide, or butylene 1,2- or 2,3-oxide, in each case alone or in the form of a mixture. In one embodiment, the alkylene oxide comprises ethylene oxide and/or propylene 1,2-oxide.

Starter molecules that can be used are compounds containing hydroxyl groups or containing amine groups, for example ethylene glycol, diethylene glycol, glycerol, trimethylolpropane, pentaerythritol, sugar derivatives, for example sucrose, hexitol derivatives, for example sorbitol, methylamine, ethylamine, isopropylamine, butylamine, benzylamine, aniline, toluidine, toluenediamine (TDA), naphthylamine, ethylenediamine, diethylenetriamine, 4,4′-methylenedianiline, 1,3,-propanediamine, 1,6-hexanediamine, ethanolamine, diethanolamine, triethanolamine, and also other di- or polyhydric alcohols or mono- or polyfunctional amines. These high-functionality compounds are solid under the usual alkoxylation reaction conditions, and it is therefore usual to alkoxylate these together with co-initiators. Examples of suitable co-initiators are water, polyhydric lower alcohols, e.g. glycerol, trimethylolpropane, pentaerythritol, diethylene glycol, ethylene glycol, propylene glycol and homologs of these. Examples of other co-initiators that can be used are: organic fatty acids, fatty acid monoesters and fatty acid methylesters, for example oleic oil, stearic acid, methyl oleate, methyl stearate or biodiesel, where these serve to improve blowing agent solubility during the production of PU foams.

Suitable starter molecules for the production of polyether polyols comprise sorbitol, sucrose, ethylenediamine, TDA, trimethylolpropane, pentaerythritol, glycerol, biodiesel, diethylene glycol or a mixture thereof. In one embodiment, the starter molecules comprise sucrose, glycerol, biodiesel, pentaerythritol, ethylenediamine or a mixture thereof.

The average functionality of the polyether polyols, as described hereinabove, is in between 2.0 to 4.0, or in between 2.5 to 4.0, with the hydroxyl number in between 10 mg KOH/g to 500 mg KOH/g, or in between 10 mg KOH/g to 400 mg KOH/g, or in between 10 mg KOH/g to 300 mg KOH/g, or in between 10 mg KOH/g to 200 mg KOH/g, or in between 10 mg KOH/g to 100 mg KOH/g or even in between 10 mg KOH/g to 70 mg KOH/g.

In yet other embodiment, the (P1) at least one polyol is a polyester polyol. Suitable polyester polyols have an average functionality in between 2.0 to 4.0 with the hydroxyl number in between 10 mg KOH/g to 500 mg KOH/g. These polyols are based on the reaction product of carboxylic acids or anhydrides with hydroxyl group containing compounds. Suitable carboxylic acids or anhydrides have preferably from 2 to 20 carbon atoms, or from 4 to 18 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, oleic acid, phthalic anhydride.

Suitable hydroxyl-containing compounds comprise one or more selected from ethanol, ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside, diethylene glycol, triethylene glycol, tetraethylene glycol, polyethylene glycol, dipropylene glycol, polypropylene glycol, polyethylene-propylene glycol, dibutylene glycol and polybutylene glycol. In one embodiment, the hydroxyl-containing compounds comprise one or more selected from ethylene glycol, propylene-1,2-glycol, propylene-1,3-glycol, butyl-ene-1,4-glycol, butylene-2,3-glycol, hexane-1,6-diol, octane-1,8-diol, neo-pentyl glycol, cyclohexane dimethanol (1,4-bis-hydroxy-methylcyclohexane), 2-methyl-propane-1,3-diol, glycerol, trimethylolpropane, hexane-1,2,6-triol, butane -1,2,4-triol, trimethylolethane, pentaerythritol, quinitol, mannitol, sorbitol, methyl glycoside and diethylene glycol.

The polyether-ester polyols are obtainable as a reaction product of i) at least one hydroxyl-containing starter molecule; ii) of one or more fatty acids, fatty acid monoesters or mixtures thereof; iii) of one or more alkylene oxides having 2 to 4 carbon atoms.

### Step B

Step B of the process described herein includes reacting the second mixture (M2) comprising the at least one isocyanate reactive compound, the at least one catalyst (CA) and the isocyanate prepolymer of step (A) at an isocyanate index between 10 to 70 to obtain the polyurethane gel.

### Isocyanate Reactive Compound

The at least one isocyanate reactive compound has a molecular weight between 49 to 10000 g/mol. In yet other embodiment, the isocyanate reactive compound has a molecular weight between 500 to 10000 g/mol. However, the isocyanate reactive compounds having a molecular weight in between 49 g/mol to 499 g/mol are referred to as chain extenders in the present context.

In yet other embodiment, the isocyanate reactive compound comprises of hydroxyl containing compounds, polyols having nominal isocyanate reactive group functionalities of 2 to 4 or a combination thereof.

In yet other embodiment, the isocyanate reactive compound is a hydroxyl containing compound having a functionality of 2. The hydroxyl containing compound includes diols. The diols have a molecular weight between 500 g/mol to 10000 g/mol, or , or between 500 g mol to 75000 g/mol, or between 500 to 5000 g/mol. The diols have a hydroxyl number between 10 to 500 mg KOH/g.

In one embodiment the diol comprises a polyether diol.

In yet other embodiment, the polyether diol has a molecular weight of between 500 to 10000 g/mol, or between 500 to 5000 g/mol, or between 500 to 4000 g/mol, or between 1000 to 4000 g/mol, between 2000 to 4000 g/mol. In yet other embodiment, the polyether diol has a molecular weight of 3000 g/mol.

In yet other embodiment, the polyether diol has a hydroxyl number between 10 to 500 mg KOH/g, or between 10 to 400 mg KOH/g, or between 20 to 300 mg KOH/g, or between 20 to 200 mg KOH/g, or between 30 to 50 mg KOH/g.

In yet other embodiment, the polyether diol has hydroxyl number of 37 mg KOH/g.

In yet other embodiment, the polyol (P2) has an average functionality between 2.0 to 8.0, or between 2.0 to 7.5 or between 2.5 to 7.0, or between 2.5 to 6.5, or between 3.0 to 6.5, or between 3.0 to 6.0.

In yet other embodiment, the polyol (P2) has a hydroxyl number between 10 to 500 mg KOH/g or between 10 to 450 mg KOH/g, or between 10 to 400 mg KOH/g, or between 50 to 400 mg KOH/g, or between 100 to 400 mg KOH/g, or between 150 to 400 mg KOH/g, or between 200 to 400 mg KOH/g, or between 250 to 400 mg KOH/g, or between 300 to 400 mg KOH/g.

In yet other embodiment, the polyol (P2) has a molecular weight between 500 to 10000 g/mol, or between 500 to 5000g/mol, or between 500 to 2500 g/mol, or between 2000 g/mol, or between 500 to 1500 g/mol.

In yet other embodiment, the polyol (P2) includes polyether polyols, polyester polyols, polyether-ester polyols or combinations thereof.

In yet other embodiment, the polyol (P2) comprises polyether polyols.

Suitable polyether polyols are obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or po-tassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Starter molecules are generally selected such that their average functionality is in between 2.0 to 8.0, or in between 3.0 to 8.0. Optionally, a mixture of suitable starter molecules may be used.

Starter molecules for polyether polyols include amine containing and hydroxyl-containing starter molecules. Suitable amine containing starter molecules include, for example, aliphatic and aromatic diamines such as ethylenediamine, propylenediamine, butylenediamine, hexamethylenediamine, phenylenediamines, toluenediamine, diaminodiphenylmethane and isomers thereof.

Other suitable starter molecules further include alkanolamines, e.g. ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

In one embodiment, amine containing starter molecules are selected from ethylenediamine, phenylenediamines, toluenediamine and isomers thereof. In other embodiment, the amine containing starter molecules comprise toluenediamine.

In yet other embodiment, the polyether polyols, according to the invention, have an average functionality of 4.0 and a hydroxyl number of 390 mg KOH/g.

Commercially available polyether polyol available under the tradename, such as, but not limited to, Pluracol® 736 from BASF can also be used for the purpose of the present invention.

In yet other embodiment, the polyol (P2) comprise a polyester polyol.

In yet other embodiment, the polyester polyols preferably have an average functionality between 2.0 to 6.0, or between 2.0 to 5.0, or between 2.0 to 4.0. The polyester polyol has a hydroxyl number between 30 mg KOH/g to 250 mg KOH/g, or between 100 mg KOH/g to 200 mg KOH/g.

Polyester polyols, according to the present invention, are based on the reaction product of carboxylic acids or anhydrides with hydroxy group containing compounds. Suitable carboxylic acids or anhydrides have from 2 to 20 carbon atoms, or from 4 to 18 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, oleic acid, phthalic anhydride. Particularly comprising of phthalic acid, isophthalic acid, terephthalic acid, oleic acid and phthalic anhydride or combinations thereof.

The hydroxy containing compounds comprise of ethanol, ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hex-ane-1,2,6-triol, butane-1,2,4-triol, trimethylolethane, pentaerythritol, quinitol, mannitol, sorbitol, methyl glycoside, diethylene glycol, triethylene glycol, tetraethylene glycol, polyethylene glycol, dipropylene glycol, polypropylene glycol, polyethylene-propylene glycol, dibutylene glycol and polybutylene glycol. The hydroxy containing compounds comprise of ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3 -diol, glycerol, trimethylolpropane, hexane-1,2,6-triol, butane-1,2,4-triol, trimethylolethane, pentaerythritol, quinitol, mannitol, sorbitol, methyl glycoside and diethylene glycol or combinations thereof. In some embodiments, the hydroxy containing compounds comprise of ethylene glycol, propylene-1,2-glycol, propylene-1,3-glycol, butyl-ene-1,4-glycol, butylene-2,3-glycol, hexane-1,6-diol, octane-1,8-diol, neopentyl glycol and diethylene glycol or combinations thereof. In other embodiments, the hydroxy containing compounds are selected from hexane-1,6-diol, neopentyl glycol and diethylene glycol or combinations thereof.

Suitable polyether-ester polyols have preferably a hydroxyl number between 100 mg KOH/g to 460 mg KOH/g, or between 150 mg KOH/g to 450 mg KOH/g, or even between 250 mg KOH/g to 430 mg KOH/g. The polyether-ester polyols have an average functionality between 2.3 to 5.0, or even between 3.5 to 4.7.

Such polyether-ester polyols are obtainable as a reaction product of i) at least one hydroxyl-containing starter molecule; ii) of one or more fatty acids, fatty acid monoesters or mixtures thereof; iii) of one or more alkylene oxides having 2 to 4 carbon atoms.

### Catalyst (CA)

The step (B) in the above process includes addition of the at least one catalyst (CA). Suitable catalysts for the process are well known to the person skilled in the art. For instance, tertiary amine and phosphine compounds, metal catalysts such as chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt and mixtures thereof can be used as catalysts.

In one embodiment, the tertiary amines are selected from triethylamine, tributylamine, N-methylmorpholine, N-ethylmorpholine, N,N, N′,N′-tetramethylethylenediamine, pentamethyl-diethylenetriamine and higher homologues (as described in, for example, DE-A 2,624,527 and 2,624,528), 1,4-diazabicyclo(2.2.2)octane, N-methyl-N′-dimethyl-aminoethylpiperazine, bis-(dimethylaminoalkyl)piperazines, tris(dimethylaminopropyl)hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′,N′-tetramethyl-1,3-butanediamine, N,N-dimethyl-p-phenylethylamine, 1,2-dimethylimidazole, 2-methylimidazole, monocyclic and bicyclic amines together with bis-(dialkylamino)alkyl ethers, such as 2,2-bis-(dimethylaminoethyl)ether. Triazine compounds, such as, but not limited to, tris(dimethylaminopropyl)hexahydro-1,3,5-triazin can also be used.

In another embodiment, the metal catalysts include metal salts and organometallics selected from tin-, titanium-, zirconium-, hafnium, bismuth-, zinc-, aluminium- and iron compounds, such as tin organic compounds, tin alkyls, such as dimethyltin or diethyltin, or tin organic compounds based on aliphatic carboxylic acids, tin diacetate, tin dilaurate, dibutyl tin diacetate, dibutyl tin dilaurate, bismuth compounds, such as bismuth alkyls or related compounds, or iron compounds, such as iron-(I1)-acetylacetonate or metal salts of carboxylic acids, such as tin-II-isooctoate, tin dioctoate, titanium acid esters or bismuth-(III)-neodecanoate or combinations thereof. In yet other embodiment, the at least one catalyst (CA) used in the Step (B) comprises metallo-organic catalysts, tertiary amine catalysts, or a combination thereof.

In yet other embodiment, the at least one catalyst (CA) used in the Step (B) includes dibutylin dilaurate (DBTDL).

In yet other embodiment, the weight ratio of the first mixture (M1) to the second mixture (M2) is between 1.0:3.0 to 1.0:5.0. In yet another embodiment, the weight ratio of the first mixture (M) to the second mixture (M2) is between 1.0:3.0 to 1.0:4.5, or between 1.0:3.5 to 1.0:4.5.

In yet other embodiment, the polyurethane gel is free of additives. In other words, the polyurethane gel comprises no additive in an amount exceeding 0.1% to 0.01% by weight of the total weight of the polyurethane gel. In yet other embodiment, the polyurethane gel comprises no additive in an amount exceeding 0.01% by weight of the total weight of the polyurethane gel. The additives comprise of plasticizers, amines, or combinations thereof. When used in a polyurethane system or the polyurethane gel, plasticizers are an unreactive component and simply get tied up in the polymer matrix. Over time, this unreacted component can exude from the polymer and, in a liquid form, be transferred to any substrate that comes into contact with the polymer. By not having any plasticizers in this system, this possibility is eliminated.

The additives can comprise one or more pigments, dyes, flame retardants, hindered amine light stabilizers, ultraviolet light absorbers, stabilizers, defoamers, internal release agents, desiccants, blowing agents and anti-static agents or combinations thereof. Further details regarding additives can be found, for example, in the Kunststoffhandbuch, Volume 7, “Polyurethane” Carl-Hanser-Verlag Munich, 1st edition, 1966 2nd edition, 1983 and 3rd edition, 1993.

In yet other embodiment, the polyurethane gel is free of the plasticizer. In yet other embodiment, the polyurethane gel is specifically free of the non-polyalcoholic plasticizer.

In yet other embodiment, the polyurethane gel does not contain plasticizers, amines, or a combination thereof that can negatively react with a user. A user includes an individual using the polyurethane gel. The user includes the individual under medical supervision, a medical supervisor or a medical attendant, a patient, and the like.

In yet other embodiment, the polyurethane gel is compatible for direct skin contact.

In yet other embodiment, the polyurethane gel, as obtained herein, has a gel time between 10 to 90 mins, or between 15 to 90 mins, or between 15 to 75 mins, or between 15 to 60 mins, or between 15 to 45 mins, or between 15 to 30 mins.

In yet other embodiment, the polyurethane gel has for a 50% compression, a Compression Load Deflection value between 10 to 350 kPa, or between 10 to 300 kPa, or between 10 to 250 kPa, or between 10 to 200 kPa, or between 10 to 150 kPa, or between 10 to 100 kPa, or between 10 to 90 kPa.

For the purpose of the invention, the procedure for measuring the compression load of the gel was performed as per METHOD A.

### METHOD A

The method describes the measurement of total load required to compress (or deflect) a “foot” area i.e. 0.002565 m² (i.e. “foot” area/3.9761 in²) of the polyurethane gel to deflection of 0.00508 m (i.e. 0.2 inch) over 60 second.

The foot area i.e. 0.002565 m² of the polyurethane gel (i.e. “foot” area of 3.9761 in²) with 0.01 m (1 cm) thickness is attached to a load cell capable of measuring a force up to 445 N (100 lbs).

The apparatus is configured to measure the distance by which the polyurethane gel is moved, in order to precisely measure the deflection for 0.00508 m (0.2 inch).

The movement is done over 60 seconds, moving the material for 0.000508 m (i.e. 0.02 inch) in every 6 seconds.

At the end of the 60 seconds, a final load is recorded after the polyurethane gel of area 0.00508 m (i.e. 1 foot) has been pressed through 0.00508 m (i.e. 0.2 inch).

The load measured varies depending upon the weight ratio of the first mixture (M1) to the second mixture (M2) and (index) used to react the polyurethane gel.

Another aspect of the present invention is directed to the polyurethane gel, as described herein, having a Shore “OOO” hardness of 30 to a Shore hardness of “OO” hardness of 80 determined according to ASTM D2240.

### Step (S)

Another aspect of the present invention is directed to a process for producing a polyurethane gel pad comprising at least the step of:
(S) enclosing the at least one polyurethane gel, as described herein, within an encapsulating material.

The encapsulating material provides for a cover over the polyurethane gel, as described herein. In an embodiment, the encapsulating material completely or partially encloses the polyurethane gel.

In yet other embodiment, the enclosing material completely encloses the polyurethane gel. The enclosing material is injected with the isocyanate prepolymer of step (A) and the second mixture (M2). Air is removed from the enclosing material and injection point of the enclosing material is sealed. The polyurethane gel is formed and stays within the bag.

In yet other embodiment, the at least one polyurethane gel does not react with the encapsulating material.

### Thermoplastic Polyurethane (TPU)

In yet other embodiment, the encapsulating material is a polymeric material. Suitable polymeric material is a thermoplastic polyurethane (TPU). TPU are multi-block copolymers with hard and soft segments that can be produced by a poly-addition reaction of an isocyanate with a linear polymer glycol and a low molecular weight diol as a chain extender. Usually, the soft segments form an elastomer matrix which gives the TPUs elastic properties. The hard segments typically act as multifunctional tie points that function both as physical crosslinks and reinforcing fillers. TPU includes, but is not limited to, polyester-based TPUs, polyether-based TPUs, and combinations thereof. Other suitable TPUs do not include ether or ester groups present therein. TPU comprises a reaction product of a polyol and an isocyanate. The polyol used to form the TPU has a weight average molecular weight of from 600 to 2,500 g/mol. The isocyanate that is used to form the TPU may be a polyisocyanate having two or more functional groups, e.g. two or more NCO functional groups. The isocyanate may include, but is not limited to, monoisocyanates, diisocyanates, polyisocyanates, biurets of isocyanates and polyisocyanates, isocyanurates of isocyanates and polyisocyanates, and combinations thereof.

In yet other embodiment, the TPU is polyester-based and includes the reaction product of a polyester polyol and an isocyanate. Suitable polyester polyols may be produced from a reaction of a dicarboxylic acid and a glycol.

In yet other embodiment, the TPU further includes a reaction product of a chain extender, in addition to the polyester polyols or the polyether polyols in the polyester-based or the polyether based polyols. Suitable chain extender includes but is not limited to diols, including ethylene glycol, propylene glycol, butylene glycol, or combinations thereof. In yet another embodiment, the isocyanate and the polyol and/or chain extender are reacted at an isocyanate index of from 90 to 115, more typically from 95 to 105, and most typically from 105 to 110.

In yet other embodiment, the TPU material encapsulating the polyurethane gel is inert and non-reactive.

Another aspect of the present invention is directed to the use of the polyurethane, as described herein, in an article. In an embodiment, the article is selected from padding materials for wheel chairs, beds, benches, mattresses, positioners, person support apparatus, and medical equipment.

In yet other embodiment, the article is used for medical purposes, such as but not limited to, providing support and comfort to the patient.

The present invention is illustrated in more detail by the following embodiments and combinations of embodiments which result from the corresponding dependency references and links:
1. A process for preparing a polyurethane gel having a Shore “OOO” hardness of 30 to a Shore “OO” hardness of 80 determined according to ASTM D2240, comprising the steps of:
(A) reacting a first mixture (M1) comprising
   (PI) at least one isocyanate and
   (P1) at least one polyol having an average functionality between 2.0 to 4.0 and a hydroxyl number value between 10 mg KOH/g to 500 mg KOH/g,
to prepare an isocyanate prepolymer having an isocyanate content between 4 wt.-% to 22 wt.-%, and
(B) reacting a second mixture (M2) comprising at least one isocyanate reactive compound, at least one catalyst (CA) and the isocyanate prepolymer of step (A) at an isocyanate index between 10 to 70, to obtain the polyurethane gel, and
wherein weight ratio of the first mixture (M1) to the second mixture (M2) is between 1.0:3.0 to 1.0:5.0.
2. The process according to embodiment 1, wherein the polyurethane gel has a Shore “OOO” hardness of 35 to 65 determined according to ASTM D2240.
3. The process according to embodiments 1 or 2, wherein the first mixture (M1) has an isocyanate index between 10 to 70.
4. The process according to one or more of embodiments 1 to 3, wherein the isocyanate prepolymer has an isocyanate content between 4.0 wt.-% to 8.0 wt.-%.
5. The process according to one or more of embodiments 1 to 4, wherein the at least one isocyanate (PI) comprises an aromatic isocyanate or an aliphatic isocyanate or a combination thereof.
6. The process according to embodiment 5, wherein the aromatic isocyanate comprises toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′‘-diethyl-bisphenyl-4,4′’-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4, 6-triisocyanate; 1-ethyl-3,5-diisopropyl benzene-2,4,6-triisocyanate, tolidine diisocyanate, 1,3,5-triisopropyl benzene-2,4,6-triisocyanate or combinations thereof.
7. The process according to embodiment 6, wherein the aromatic isocyanate comprises methylene diphenyl diisocyanate, or polymeric methylene diphenyl diisocyanate or a combination thereof.
8. The process according to one or more of embodiments 1 to 7, wherein the at least one polyol (P1) comprises polyether polyols or polyester polyols or a combination thereof.
9. The process according to embodiment 8, wherein the at least one polyol (P1) is a polyether polyol having an average functionality between 2.5 to 4.0 and a hydroxyl number between 10 mg KOH/g to 70 mg KOH/g.
10. The process according to one or more of embodiments 1 to 9, wherein the isocyanate reactive compound has a molecular weight between 49 to 10000 g/mol.
11. The process according to embodiment 10, wherein the isocyanate reactive compound comprises diols or polyols (P2), or a combination thereof.
12. The process according to embodiment 11, wherein the diol has a molecular weight between 500 to 5000 g/mol.
13. The process according to embodiment 12, wherein the diol is a polyether diol.
14. The process according to embodiment 11, wherein the polyol (P2) has an average functionality between 3.0 to 6.0 and a molecular weight between 500 to 1500 g/mol.
15. The process according to embodiment 14, wherein the polyol (P2) comprises polyester polyols, polyether polyols, polyether-ester polyols, or combinations thereof.
16. The process according to embodiment 15, wherein the polyol (P2) is a polyether polyol.
17. The process according to one or more of embodiments 1 to 16, wherein the at least one catalyst comprises metallo-organic catalysts, tertiary amine catalysts, or a combination thereof.
18. The process according to one or more of embodiments 1 to 17, wherein the polyurethane gel is free of additives selected from plasticizers, amines, or combinations thereof.
19. The process according to embodiment 18, wherein the plasticizer is a non-polyalcoholic plasticizer.
20. The process according to one or more of embodiments 1 to 19, wherein the polyurethane gel has a gel time between 10 to 90 mins.
21. The process according to one or more of embodiments 1 to 20, wherein the polyurethane gel has a Compression Load Deflection value between 10 kPa to 90 kPa for 50% compression.
22. The process according to one or more of embodiments 1 to 21, wherein the polyurethane gel is compatible for direct skin contact.
23. A polyurethane gel obtained by the process according to one or more of embodiments 1 to 22 having a Shore “OOO” hardness of 30 to a Shore “OO” hardness of 80 determined according to ASTM D2240.
24. A process for producing a polyurethane gel pad comprising at least the step of:
   (S) enclosing at least one polyurethane gel according to embodiment 23 or as obtained by the process according to one or more of embodiments 1 to 22, within an encapsulating material.
25. The process according to embodiment 24, wherein the encapsulating material completely or partially encloses the polyurethane gel.
26. The process according to embodiments 24 or 25, wherein the at least one polyurethane gel does not react with the encapsulating material.
27. The process according to one or more of embodiments 24 to 26, wherein the encapsulating material is a polymeric material.
28. The process for according to embodiment 27, wherein the polymeric material is a thermoplastic polyurethane.
29. Use of a polyurethane gel pad obtained by the process according to one or more of embodiments 24 to 28 in an article.
30. The use according to embodiment 29, wherein the article is selected from padding materials for wheel chairs, beds, benches, mattresses, positioners, person support apparatus, and medical equipment.

### EXAMPLES

The present invention is further illustrated in combination with the following examples. These examples are provided to exemplify the present invention but are not intended to restrict the scope of the presently claimed invention in any way. The terms and abbreviations in the examples have their common meanings. For example, “%”, “% NCO”, “Eq. wt.”, “Eq.”, “° C”, “wt. %”, “% w/w”, “% w/v” and “gm” represent “percentage”, “isocyanate content/percent Nitrogen Carbon Oxygen”, “Equivalent Weight”, “Equivalents”, “degree Celsius”, “percent by weight”, “percent weight by weight”, “percent weight by volume” and “gram” respectively.

### Compounds

ISOCYANATE

| | |
|---|---|
| PI1 | Monomeric MDI with NCO content of 33.5 wt.-% and |
| | functionality = 2.0, obtained from BASF |
| PI2 | Polymeric MDI with NCO content of 31.5 wt.-% and |
| | functionality = 2.7, obtained from BASF |

POLYOL

| | |
|---|---|
| P11 | Polyether polyol based on glycerine, ethylene oxide |
| | (EO) and propylene oxide (PO); hydroxyl number = |
| | 35 mg KOH/g, functionality = 3, obtained from BASF |
| P21 | Polyether polyol based on toluenediamine and propylene |
| | oxide (PO); hydroxyl number = 390 mg KOH/g, |
| | functionality = 4, obtained from BASF |

DIOL

| | |
|---|---|
| D1 | Polyether diol; hydroxyl number = 37 mg KOH/g, |
| | molecular weight = 3000 |

CATALYST

| | |
|---|---|
| Cat1 | Dibutyltin dilaurate catalyst obtained from Evonik (Dabco T12) |

### Analytical Methods

### Compression Load Deflection Measurement

The procedure describes the measurement of total load required to compress (or deflect) a “foot” area i.e. 0.002565 m² (i.e. “foot” area/3.9761 in²) of the polyurethane gel to deflection of 0.00508 m (i.e. 0.2 in) over 60 second. The specimen of material had 0.01 m (1 cm) thickness. The deflection of 0.00508 m (i.e. 0.2 in) corresponded to approx. 50% compression.

The foot area i.e. 0.002565 m² of the polyurethane gel (i.e. “foot” area of 3.9761 in²) was attached to a load cell capable of measuring a force up to 445 N (100 lbs).

The apparatus was configured to measure the distance by which the polyurethane gel was moved, in order to precisely measure the deflection for 0.00508 m (0.2).

The movement was done over 60 seconds, moving the material for 0.000508 m (i.e. 0.02 inch) in every 6 seconds.

At the end of the 60 seconds, a final load was recorded after the polyurethane gel of area 0.00508 m (i.e. 1 foot) has been pressed through 0.00508 m (i.e. 0.2 in).

The load measured varied depending upon the ratio of the first mixture (M1) to the second mixture (M2) and (index) used to react the polyurethane gel.

### Synthesis of Polyurethane Gel

A polyurethane gel was produced by the below process with step (A) and step (B). In step (A), the first mixture (M1) comprising compounds as mentioned in Table 1, were reacted. The compounds were reacted to form total 100 parts of an isocyanate prepolymer having an isocyanate content of 5.75.

TABLE 1
Isocyanate prepolymer

| Component | (wt.-%) |
|---|---|
| PI1 | 125.43 |
| PI2 | 133.39 |
| P11 | 1602.85 |

Properties

| | |
|---|---|
| NCO content | 5.7448 |

The step (B) included reacting the second mixture (M2) with the isocyanate prepolymer obtained from step (A) at an isocyanate index of 41 to obtain the polyurethane gel. The compounds comprised in the second mixture (M2) were as mentioned in Table 2.

TABLE 2
Second Mixture composition

| Component | (wt.-%) |
|---|---|
| P21 | 2.00 |
| D1 | 97.70 |
| Cat1 | 0.30 |

Properties

| | |
|---|---|
| NCO content | 5.7448 |

The Polyurethane gels with composition (Compositions C1 to C9) were prepared with the weight ratio of the first mixture (M1) to the second mixture (M2) is between 1:3.5 to 1:4.5 as mentioned in Table 3. The Shore “OOO” hardness for the polyurethane gel was measured as according to ASTM D2240. The firmness of the polyurethane gel was measured by assessing the force required for full 0.2 inches (approx. 0.5 cm) deflection on a 1.0 cm thick specimen (approx. 50% compression). The corresponding Compressive Load Deflection (CLD) was also provided. The process used to measure the CLD value was as per METHOD A.

TABLE 3
Polyurethane gel compositions (C1 to C9) with the corresponding
Shore hardness, Force measured over the foot area (0.002565
m²) and corresponding CLD values.

| | | | Shore | | |
|---|---|---|---|---|---|
| | | Isocyanate | OOO | Force | CLD |
| Composition | M1:M2 | Index | hardness | measured | value |
| C1 | 0.199 | 35.5 | 39 | 36.47N | 14.22 kPa |
| C2 | 0.210 | 37.4 | 42 | 78.24N | 30.50 kPa |
| C3 | 0.221 | 39.3 | 45 | 120.19N | 46.85 kPa |
| C4 | 0.230 | 40.9 | 48 | 173.97N | 67.82 kPa |
| C5 | 0.241 | 42.7 | 51 | 222.41N | 86.70 kPa |
| C6 | 0.251 | 44.6 | 54 | 222.41N | 86.70 kPa |
| C7 | 0.261 | 46.4 | 57 | 222.41N | 86.70 kPa |
| C8 | 0.271 | 48.2 | 60 | 222.41N | 86.70 kPa |
| C9 | 0.280 | 49.8 | 62 | 222.41N | 86.70 kPa |

In Step (S) the polyurethane gel produced was enclosed within a thermoplastic polyurethane bag to form a polyurethane gel pad.

1. A process for preparing a polyurethane gel having a Shore “OOO” hardness of 30 to a Shore “OO” hardness of 80 determined according to ASTM D2240, comprising the steps of:
(A) reacting a first mixture (M1) comprising:
(PI) at least one isocyanate and
(P1) at least one polyol having an average functionality between 2.0 to 4.0 and an hydroxyl number between 10 mg KOH/g to 500 mg KOH/g,
to prepare an isocyanate prepolymer having an isocyanate content between 4.0 wt.-% to 22.0 wt.-%, and
(B) reacting a second mixture (M2) comprising at least one isocyanate reactive compound, at least one catalyst (CA) and the isocyanate prepolymer of step (A) at an isocyanate index between 10 to 70, to obtain the polyurethane gel,
wherein weight ratio of the first mixture (M1) to the second mixture (M2) is between 1.0:3.0 to 1.0:5.0.

2. The process according to claim 1, wherein the polyurethane gel has a Shore “OOO” hardness of 35 to a Shore “OO” hardness of 50 determined according to ASTM D2240.

3. The process according to claim 1, wherein the first mixture (M1) has an isocyanate index between 10 to 70.

4. The process according to claim 1, wherein the isocyanate prepolymer has an isocyanate content between 4.0 wt.-% to 8.0 wt.-%.

5. The process according to claim 1, wherein the at least one isocyanate (PI) comprises an aromatic isocyanate or an aliphatic isocyanate or a combination thereof.

6. The process according to claim 5, wherein the aromatic isocyanate comprises toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1, 3-phenylene diisocyanate; 2,4,6-toluylene triisocyanate, 1,3 -diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2, 5 -diisocyanate; 1,3,5-triethyl benzene-2,4,6-triisocyanate; 1-ethyl-3,5-diisopropyl benzene-2,4,6-triisocyanate, tolidine diisocyanate, 1,3,5-triisopropyl benzene-2,4,6-triisocyanate, or combinations thereof.

7. The process according to claim 6, wherein the aromatic isocyanate comprises methylene diphenyl diisocyanate, or polymeric methylene diphenyl diisocyanate or combination thereof.

8. The process according to claim 1, wherein the at least one polyol (P1) comprises polyether polyols or polyester polyols or combination thereof.

9. The process according to claim 8, wherein the at least one polyol (P1) is a polyether polyol having an average functionality between 2.5 to 4.0 and a hydroxyl number between 10 mg KOH/g to 70 mg KOH/g.

10. The process according to claim 1, wherein the isocyanate reactive compound has a molecular weight between 49 to 10000 g/mol.

11. The process according to claim 10, wherein the isocyanate reactive compound comprises diols or polyols (P2), or a combination thereof.

12. The process according to claim 11, wherein the diol has a molecular weight between 500 to 5000 g/mol.

13. The process according to claim 12, wherein the diol is a polyether diol.

14. The process according to claim 11, wherein the polyol (P2) has an average functionality between 3.0 to 6.0 and a molecular weight between 500 to 1500 g/mol.

15. The process according to claim 14, wherein the polyol (P2) comprises polyester polyols, polyether polyols, polyether-ester polyols, or combinations thereof.

16. The process according to claim 15, wherein the polyol (P2) is a polyether polyol.

17. The process according to claim 1, wherein the at least one catalyst comprises metallo-organic catalysts, tertiary amine catalysts, or combination thereof.

18. The process according to claim 1, wherein the polyurethane gel is free of additives selected from the group consisting of plasticizers, amines, and combinations thereof.

19. The process according to claim 18, wherein the plasticizer is a non-polyalcoholic plasticizer.

20. The process according claim 1, wherein the polyurethane gel has a gel time between 10 to 90 mins.

21. The process according to claim 1, wherein the polyurethane gel has a Compression Load Deflection value between 10 kPa to 90 kPa for 50% compression.

22. The process according to claim 1, wherein the polyurethane gel is compatible for direct skin contact.

23. A polyurethane gel obtained by the process according to claim 1 having a Shore “OOO” hardness of 30 to a Shore “OO” hardness of 80 determined according to ASTM D2240.

24. A polyurethane gel having a Shore “OOO” hardness of 30 to a Shore “OO” hardness of 80 determined according to ASTM D2240, which is obtained by reacting:
a prepolymer comprising the reaction product of:
(PI) at least one isocyanate, and
(P1) at least one polyol having an average functionality between 2.0 to 4.0 and a hydroxyl number between 10 mg KOH/g to 500 mg KOH/g,
whereby the isocyanate prepolymer has an isocyanate content between 4.0 wt.-% to 22.0 wt.-%, based on the weight of the prepolymer, and
at least one isocyanate reactive compound and at least one catalyst (CA) at an isocyanate index between 10 to 70.

25. A process for producing a polyurethane gel pad comprising at least the step of:
(S) enclosing at least one polyurethane gel according to claim 23 within an encapsulating material.

26. The process according to claim 25, wherein the encapsulating material completely or partially encloses the polyurethane gel.

27. The process according to claim 25, wherein the at least one polyurethane gel does not react with the encapsulating material.

28. The process according to claim 25, wherein the encapsulating material is a polymeric material.

29. The process for according to claim 28, wherein the polymeric material is a thermoplastic polyurethane.

30. A method of using a polyurethane gel pad obtained by the process according to claim 25, the method comprising using the polyurethane gel pad in an article.

31. The method of using a polyurethane gel pad according to claim 30, wherein the article is selected from the group consisting of padding materials for wheel chairs, beds, benches, mattresses, positioners, person support apparatus, and medical equipment.
